(19) United States
(12) Patent Application Publication
(10) Pub. No.: US 2018/0105359 A1
(43) Pub. Date: Apr. 19, 2018

(54) LATCH HANDLE FOR STORAGE CONTAINER

(71) Applicant: Anthony Richard Chapman, Norman, OK (US)

(72) Inventor: Anthony Richard Chapman, Norman, OK (US)

(21) Appl. No.: 15/847,461

(22) Filed: Dec. 19, 2017

(51) Int. Cl. B65F 1/16

(52) U.S. Cl. CPC B65F 1/1615

(57) ABSTRACT

The various embodiments herein provide a latching handle comprising a base bar and a handle. The base bar is attached to a targeted surface through a fastening mechanism in a preferable axis. The handle is connected perpendicularly to the base bar. The handle latches into surface of an article to which the base bar is attached. A self-latching and unlatching of the handle with respect to the surface of the article is achieved by using a force.

### BACKGROUND

### Technical Field of Invention

The embodiments herein generally relate to a locking device and particularly relates to a latch handle for storage container. The embodiments herein more particularly relates to a latching apparatus for self-locking and unlocking.

### Description of Related Art

A locking handle for a container lid, a door or any enclosure is a device to closing and opening of the targeted article as per user choice. For doors, vertical locking handles are used while for the containers small handle are used. These handles have to be manually operated. In case of a garbage can, no locking handle are generally provided and if provided then they have to be manually operated which leads to uneasiness during unloading garbage in the garbage trucks.

In the view of foregoing, there is a need for a latching handle with self-locking and unlocking mechanism. Also, there is a need for a latching handle with a universal assembly structure that is suited for a range of doors, lids, and flaps.

The above-mentioned shortcomings, disadvantages and problems are addressed herein, as detailed below.

### SUMMARY OF THE INVENTION

The primary object of the embodiments herein is to provide a latching handle with self-locking and unlocking mechanism.

Another object of the embodiments herein is to provide a latching handle with a universal assembly structure that is suited for a range of doors, lids, and flaps.

The various embodiments herein provide a latching handle comprising a base bar and a handle. The base bar is attached to a targeted surface through a fastening mechanism in a preferable axis. The handle is connected perpendicularly to the base bar. The handle latches into surface of an article to which the base bar is attached. A self-latching and unlatching of the handle with respect to the surface of the article is achieved by using a force.

According to one embodiment of the present invention, the targeted surface comprises preferably but not limited to a lid of a container. The targeted surface further comprises a door, a window and a pane of an enclosure.

According to one embodiment of the present invention, the preferable axis of fastening mechanism is vertical as well as horizontal axis depending on the targeted surface.

According to one embodiment of the present invention, the handle has U-shaped design leading a knuckle latching action under gravity.

These and other aspects of the embodiments herein will be better appreciated and understood when considered in conjunction with the following description and the accompanied drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanied drawings in which:

FIGS. 1a and 1b illustrates a front view and front perspective view of a latching handle attached to a container in a locked and unlocked position respectively, according to one embodiment herein.

### DETAILED DESCRIPTION OF THE DRAWINGS

In the following detailed description, a reference is made to the accompanied drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a latching handle comprising a base bar and a handle. The base bar is attached to a targeted surface through a fastening mechanism in a preferable axis. The handle is connected perpendicularly to the base bar. The handle latches into surface of an article to which the base bar is attached. A self-latching and unlatching of the handle with respect to the surface of the article is achieved by using a force.

According to one embodiment of the present invention, the targeted surface comprises preferably but not limited to a lid of a container. The targeted surface further comprises a door, a window and a pane of an enclosure.

According to one embodiment of the present invention, the preferable axis of fastening mechanism is vertical as well as horizontal axis depending on the targeted surface.

According to one embodiment of the present invention, the handle has U-shaped design leading a knuckle latching action under gravity.

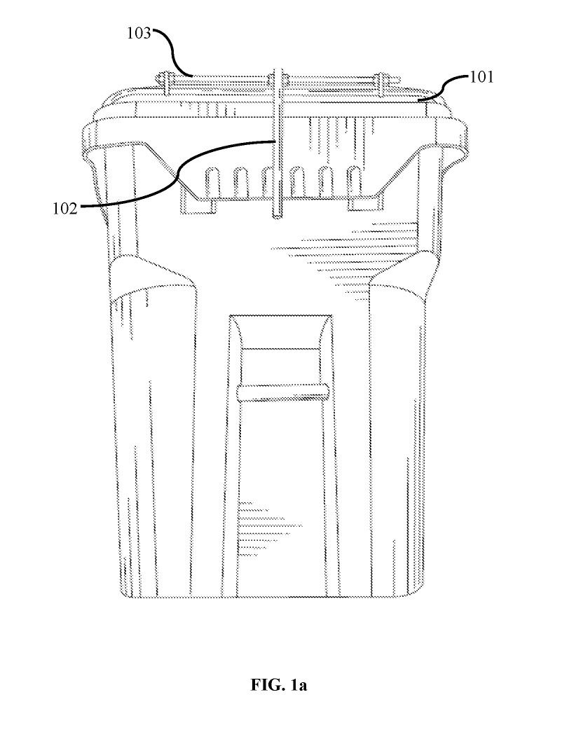

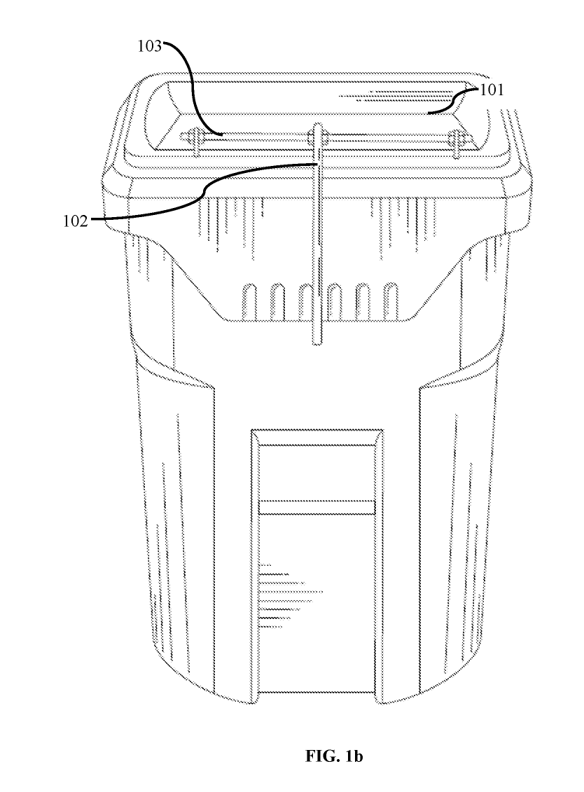

FIGS. 1a and 1b illustrates a front view and front perspective view of a latching handle attached to a container in a locked and unlocked position respectively, according to one embodiment herein. With respect to FIGS. 1a and 1b, during opening of a lid 101 by a human or a truck, the handle 102 swings open as the knuckle joint formed by U-shaped design of the handle is easily released by a momentum generated during unloading of the container. The handle 102 is connected to the lid through the base bar 103. The handle retains a locking or latching position after the lid is closed.

The present latching handle disallows a force opening of the lid of container by an animal or wind because it gets latched to the container surface under a gravitational force.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A latching handle comprising:
a base bar, wherein the base bar is attached to a targeted surface through a fastening mechanism in a preferable axis;
a handle, wherein the handle is connected perpendicularly to the base bar;
wherein, the handle latches into surface of an article to which the base bar is attached,
wherein a self-latching and unlatching of the handle with respect to the surface of the article is achieved by using a force.

2. The latching handle according to claim 1, wherein the targeted surface comprises preferably but not limited to a lid of a container.

3. The latching handle according to claim 1, wherein the preferable axis of fastening mechanism is vertical as well as horizontal axis depending on the targeted surface.

4. The latching handle according to claim 1, wherein the force for self-latching and unlatching is gravity.

5. The latching handle according to claim 1, wherein the handle has U-shaped design leading a knuckle latching action under gravity.
